(19) United States
(12) Patent Application Publication
(10) Pub. No.: US 2021/0308856 A1
(43) Pub. Date: Oct. 7, 2021

(54) EXTENSION POLE SYSTEM AND FOOT BRACE THEREFOR

(71) Applicant: John Wilson, Rancho Santa Fe, CA (US)

(72) Inventor: John Wilson, Rancho Santa Fe, CA (US)

(21) Appl. No.: 17/352,317

(22) Filed: Jun. 20, 2021

Related U.S. Application Data
(63) Continuation-in-part of application No. 16/883,967, filed on May 26, 2020, now Pat. No. 11,051,458.
(60) Provisional application No. 62/883,884, filed on Aug. 7, 2019.

(51) Int. Cl. B25G 1/04; A01G 3/08

(52) U.S. Cl. CPC B25G 1/04; A01G 3/083

(57) ABSTRACT

An extension pole system includes an extension pole and a foot brace coupled to a lower end of the extension pole. The upper end of the extension pole is configured to releasably couple to an attachment. The foot brace is configured to receive a foot of a user. The extension pole is comprised of a plurality of extension sections and a plurality of locking collars configured to releasably lock the extension sections in place. Each extension section is slidably engaged with at least one adjacent extension section, wherein the extension pole is configured to transition between a collapsed orientation and an extended orientation. Applying downward force on a base portion of the foot brace is configured to stabilize the extension pole in the vertical position, wherein the user is able to use both of his/her hands to transition the extension pole between the collapsed orientation and the extended orientation.

### CROSS-REFERENCE TO RELATED APPLICATION(S)

This application is a continuation-in-part of U.S. Nonprovisional patent application Ser. No. 16/883,967 filed May 26, 2020, which claims benefit of U.S. Provisional Patent Application No. 62/883,884 filed Aug. 7, 2019, the entire disclosures of which are incorporated by reference herein.

### BACKGROUND OF THE INVENTION

### 1. Field of Invention

This invention relates to extension pole systems for accessing elevated and otherwise hard-to-reach areas.

### 2. Description of Related Art

Extension pole systems for accessing elevated or hard-to-reach areas are known in the art. However, a major deficiency of prior systems is that they are difficult to use, especially when using longer poles. Prior systems are typically extended on the ground and are lifted into place for use. The problem with this method of use is that, as the pole is extended, it becomes increasingly more difficult to transition the pole from a horizontal position (on the ground) to a vertical position. This is due to an increase in the position of the upper end of the pole, relative to the center of rotation, i.e., the bottom of the pole. As a result, longer poles typically require multiple individuals to lift the pole into place or, when operated by a single user, pose an inherent risk of injury to the user from over-exertion.

In an effort to address the foregoing issues, a user may use an object (e.g., a ladder) to support the extension pole in the upright position during the extension process. In most cases, this would obviate the need for multiple individuals and would lessen the potential for injury to the user from over-exertion. However, it would require the user to have a separate object for supporting the extension pole.

Based on the foregoing, there is a need in the art for an extension pole system that includes a means for stabilizing the pole in a vertical position, while freeing up both of the user's hands so that the user can extend and/or retract the pole in the vertical position.

### SUMMARY OF THE INVENTION

An extension pole system includes an extension pole and a foot brace coupled to a lower end of the extension pole. The upper end of the extension pole is configured to releasably couple to an attachment. The foot brace is configured to receive a foot of a user to stabilize the extension pole when the extension pole is in an upright position. The extension pole is comprised of a plurality of extension sections and a plurality of locking collars configured to releasably lock the extension sections in place. Each extension section is slidably engaged with at least one adjacent extension section, wherein the extension pole is configured to transition between a collapsed orientation and an extended orientation.

In an embodiment, the foot brace includes one or more spikes configured to secure the foot brace to a ground surface.

In an embodiment, the extension pole is permanently attached to the foot brace.

In an embodiment, the foot brace is integrally formed as part of extension pole.

In an embodiment, the foot brace is removably coupled to the extension pole.

In various embodiments, the attachment may be a manual tool, a power tool, a cleaning tool, a cleaning device, a cleaning apparatus, a painting tool, a painting device, a painting apparatus, a camera or any other tool, device, or apparatus suitable/desirable for use with an extension pole.

In an embodiment, when the system is upright and in the collapsed orientation, an upper end of extension pole is disposed between 4 and 7 feet above a ground surface.

In an embodiment, the extension pole has one or more handle(s). In a further or alternative embodiment, the extension pole has a strap configured to secure the extension pole to an object or the user. In an embodiment, wherein the extension pole includes one or more handle(s) and a strap, the handle(s) and the strap are disposed on opposite sides of the extension pole.

In an embodiment, a method of using the extension pole system includes, with the extension pole in the collapsed orientation coupling an attachment to the upper end of the extension pole; orienting the extension pole in a vertical position with the foot brace resting on a ground surface; positioning the user's foot within the foot brace and applying downward force on a base portion of the foot brace, the base portion being located underneath the user's foot, the user extending the sections to transition the extension pole from the collapsed orientation to the expanded orientation; and, with the extension pole in the extended orientation, the user collapsing the sections to transition the extension pole from the extended orientation to the collapsed orientation. Applying downward force on a base portion of the foot brace is configured to stabilize the extension pole in the vertical position, wherein the user is able to use both of his/her hands to transition the extension pole between the collapsed orientation and the extended orientation.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 shows the extension pole system in the expanded orientation, according to an embodiment of the present invention;

FIG. 2 shows an internal view of the extension pole system, according to an embodiment of the present invention;

FIG. 3 shows the hook and a saw attachment coupled to the extension pole system, according to an embodiment of the present invention;

FIG. 4 shows the hook and a saw attachment coupled to the extension pole system, according to an embodiment of the present invention;

FIG. 5 shows the handle of the extension pole system, according to an embodiment of the present invention;

FIG. 6 shows a worker using the foot brace of the extension pole system, according to an embodiment of the present invention:

FIG. 7 shows the extension pole system in the expanded orientation, according to an embodiment of the present invention,

FIG. 8 shows an internal view of a cutting tool of the extension pole system, according to an embodiment of the present invention;

FIG. 9 shows the extension pole system in the collapsed orientation, according to an embodiment of the present invention; and

FIG. 10 shows a method of using the extension pole system, according to an embodiment of the present invention.

### DETAILED DESCRIPTION OF PREFERRED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

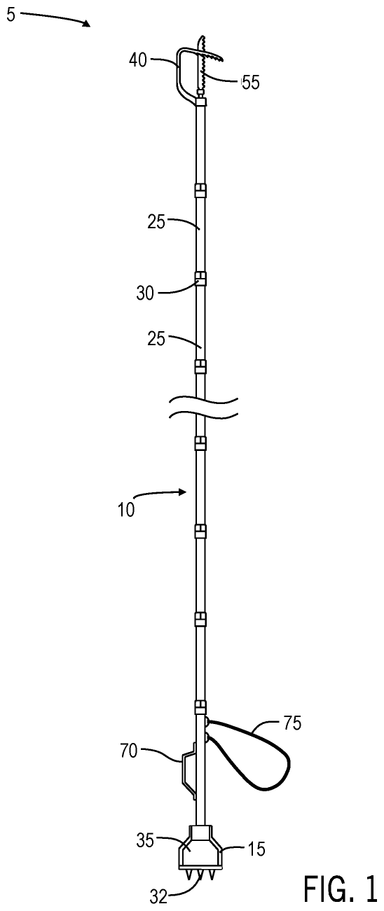

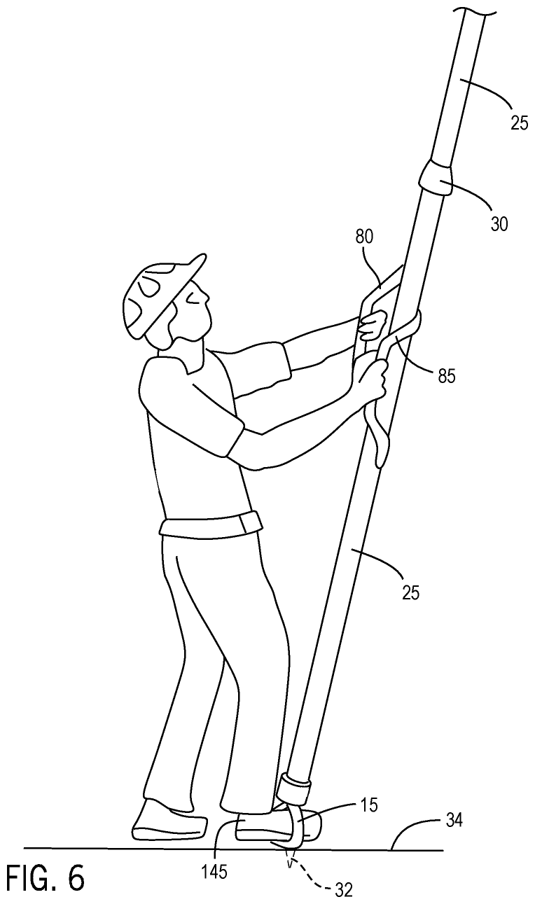

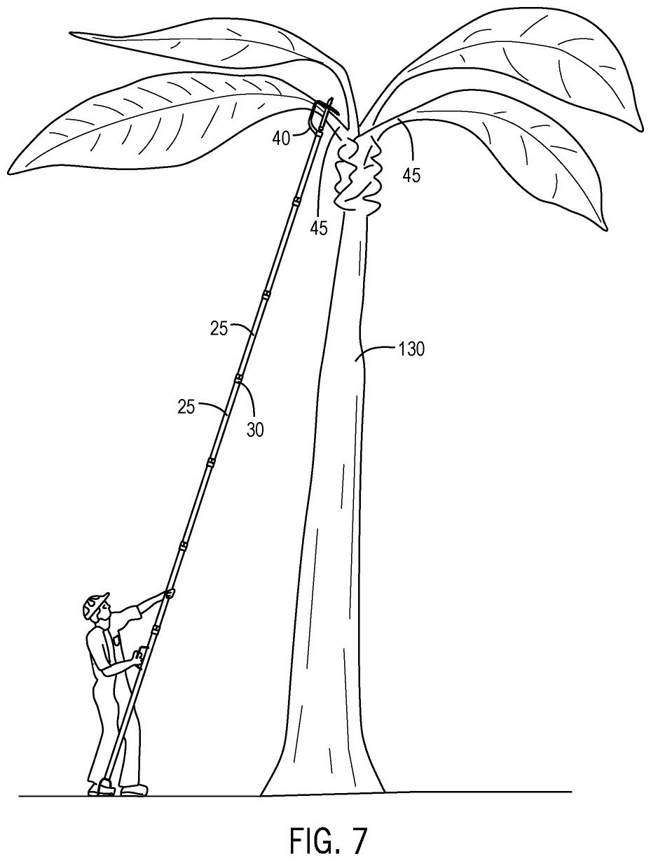

Preferred embodiments of the present invention and their advantages may be understood by referring to FIGS. 1-10 wherein like reference numerals refer to like elements.

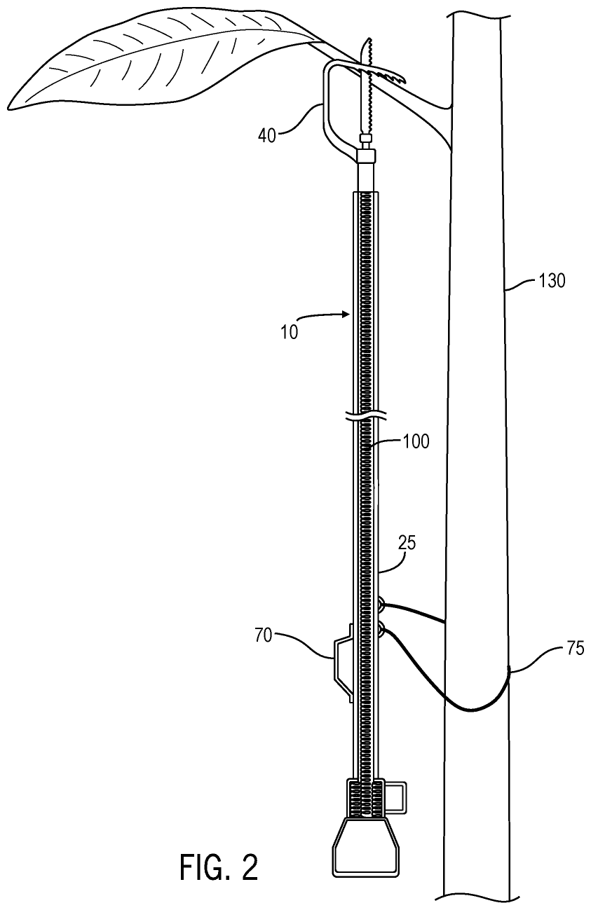

With reference to FIGS. 1-2, extension pole system 5 includes extension pole 10 and foot brace 15 coupled to a lower end of extension pole 10. The upper end of extension pole 10 is configured to releasably couple to one or more attachments 20. The drawings show cutting devices coupled to the upper end of extension pole 10. This is for illustrative purposes only and is not meant to limit the scope of the present invention to any particular attachment 20. A non-exhaustive list of attachments 20 that may be used with extension pole system 5 include manual or power tools (e.g., saws or other cutting devices, etc.), cleaning/painting tools/devices/apparatuses (e.g., vacuums, blowers, brushes, rollers, spraying devices, squeegees, scrapers, etc.), cameras, etc. Attachments 20 are removably coupled to extension pole 10, such that attachments 20 can be switched out, depending on the task to be completed.

Extension pole 10 includes a plurality of sections 25 collapsibly secured together at joints 30. Each joint 30 includes a locking mechanism (e.g., a locking collar, etc.) for temporarily/releasably locking sections 25 in place, relative to an adjacent section 25. Locking mechanisms for locking extension pole sections in place are known to those skilled in the art and can be embodied in a number of ways. As such, any known locking mechanism could be employed with the present invention without deviating from the scope of the invention. Sections 25 may be made of any material suitable for meeting the strength and safety specifications for extension poles, including, but not limited to, carbon fiber, aluminum, fiberglass, plastic, etc.

Extension pole system 5 telescopingly transitions between a collapsed, i.e., storage, orientation to an expanded, i.e., active, orientation. In an embodiment, extension and retraction of extension pole system 5 is performed manually. Alternatively, in an embodiment, extension pole system 5 includes a motor for mechanically extending and retracting extension pole 10. In an embodiment, when extension pole system 5 is upright and in the collapsed orientation, the upper end of extension pole 10 is readily accessible by both hands of the user. Thus, the user is able to manually extend sections 25, one at a time, from the lowermost, i.e., base, section 25 to transition extension pole 10 from the collapsed orientation to the expanded position. Due to the varying heights of users, the upper end of extension pole 10—when extension pole system 5 is upright and in the collapsed orientation—is preferably between 4 and 7 feet above the ground surface. This height range is for illustrative purposes and is not intended to limit the scope of the present invention.

In an embodiment, foot brace 15 is fixedly, i.e., permanently, attached to extension pole 10, e.g., using an adhesive, weld, or other permanent joining means. In another embodiment, foot brace 15 is integrally formed as part of extension pole 10, e.g., through a machining or molding process, such that foot brace 15 is in continuous, unitary construction with extension pole 10. In yet another embodiment, foot brace 15 may be removably attached to extension pole 10 via mated threading or other releasable attachment mechanism, such as a snap fit, friction fit, releasable couplers (e.g., bolts, etc.), etc. With reference to FIGS. 1, 6, and 9, in an embodiment, the bottom of foot brace 15 includes at least one spike 32 configured to penetrate a ground surface 34 to anchor, secure and stabilize extension pole system 5 while in use. In an embodiment, foot brace 15 includes an opening 35 for receiving a user's foot for enhanced stabilization during use. For example, in an embodiment, foot brace 15 is similar in shape and design to a saddle stirrup.

In an embodiment, extension pole system 5 includes a motor configured to operate attachment 20. In an embodiment, extension pole system 5 is electrically powered and is configured to receive power from an AC and/or DC power source. Alternatively, extension pole system 5 is gas powered.

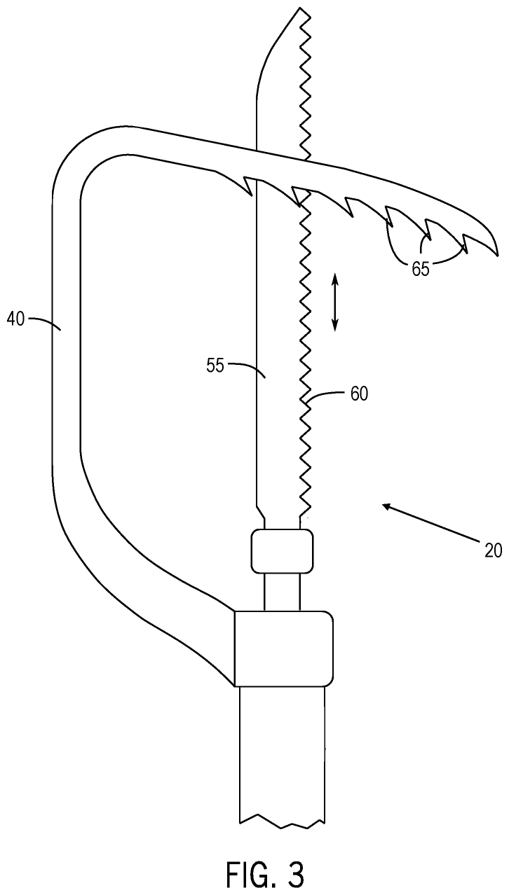

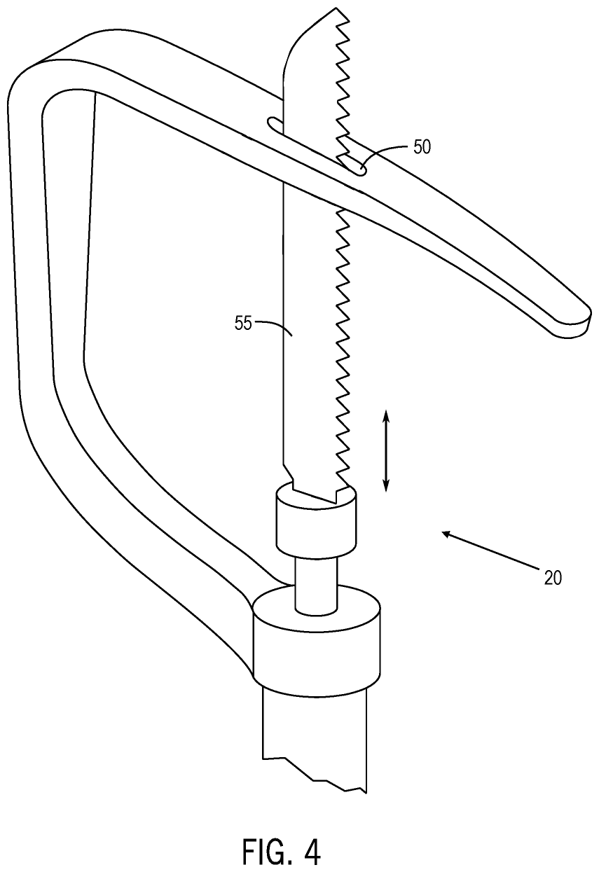

With reference to FIGS. 3-4, in an embodiment, hook 40 is disposed at the upper end of extension pole 10. Hook 40 may be generally u-shaped to facilitate engagement with an object, e.g., tree limb 45, etc. With reference to FIG. 4, in an embodiment, hook 40 includes aperture 50 configured to receive blade 55 therethrough. For example, if a reciprocating cutting device is attached to the upper end of extension pole 10, blade 55 is able to move back and forth through aperture 50. In an embodiment, hook 40 extends forward beyond the teeth 60 of blade 55 to provide enhanced stabilization of extension pole system 10. With reference to FIG. 3, in an embodiment, hook 40 may be angled slightly downward to prevent hook 40 from slipping during use. More specifically, the top of hook 40 may be less than ninety degrees with respect to the back of hook 40 for increased stability during use.

In an embodiment, hook 40 includes teeth 65. Teeth 65 may be used to “bite” into objects, e.g., tree limbs 45, to secure hook 40 and stabilize extension pole system 5 while in use. In an embodiment, teeth 65 are angled other than perpendicular to the top of hook 40. The non-perpendicular orientation of teeth 65 optimizes engagement of hook 40 with tree limb 45 during the cutting process. In an embodiment, the top of hook 40 is configured to support the weight of extension pole system 5.

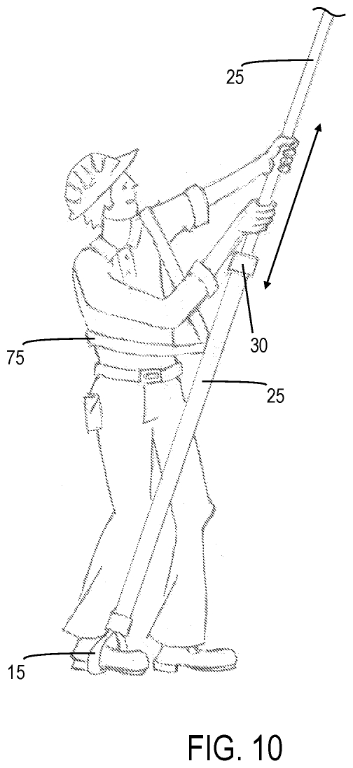

In an embodiment, handle 70 and/or securing strap/rope 75 is/are secured to the main shaft of extension pole 10. In an embodiment that includes both handle 70 and securing rope 75, handle 70 and rope 75 are on opposing sides of the main shaft, such that handle 70 allows the user to move and operate extension pole system 5 while strap/rope 75 secures extension pole system 5 to an object, e.g., a tree (as shown in FIG. 2), for added stability. As shown in FIG. 10, strap/rope 75 may be secured around the user to assist in stabilizing extension pole system 5 during use.

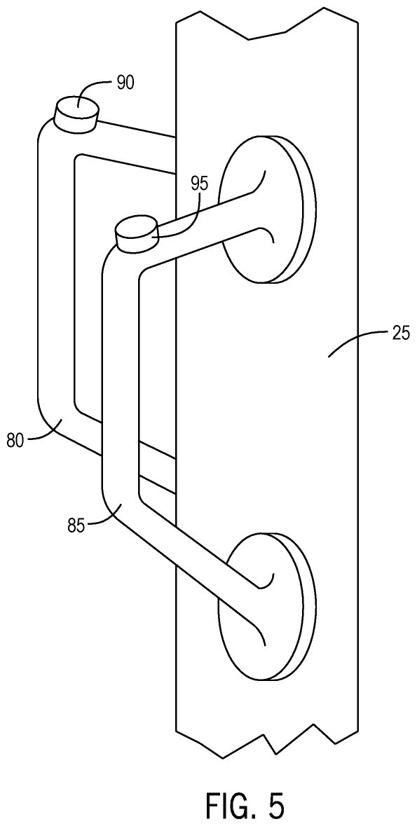

With reference to FIG. 1, in an embodiment, extension pole 10 includes a single handle 70. Alternatively, with reference to FIG. 5, in an embodiment, extension pole 10 includes more than one handle 70. In various embodiments, handle(s) 70, 80, 85 include power buttons/switches 90, 95 configured to activate a motor to mechanically control the upward and/or downward telescoping movement of sections 25 of extension pole 10. Additionally, buttons/switches 90, 95 may be used to control electric-powered attachments 20 disposed at the upper end of extension pole 10. In an embodiment, handles 70, 80, 85 may have a non-slip grip which allows for better control of extension pole system 5. For embodiments that do not include handle(s) 70, 80, 85, one or more power button(s) may be disposed on the lowermost, i.e., base, section 25 of extension pole 10.

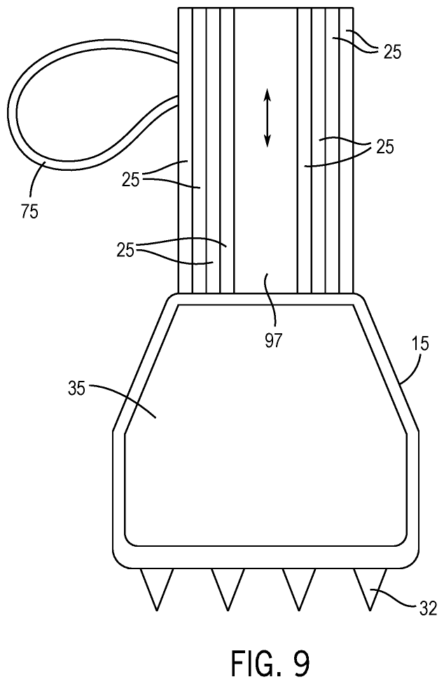

FIG. 9 illustrates a view of extension pole system 5 in the collapsed orientation (without an attachment). Extension pole 10 is configured to telescopingly collapse, whereby each section 25 slides into an adjacent section 25. In the collapsed orientation, all sections 25 are collapsed inside of the lowermost, i.e., base, section 25, such that extension pole system 5 is configured for storage/transportation.

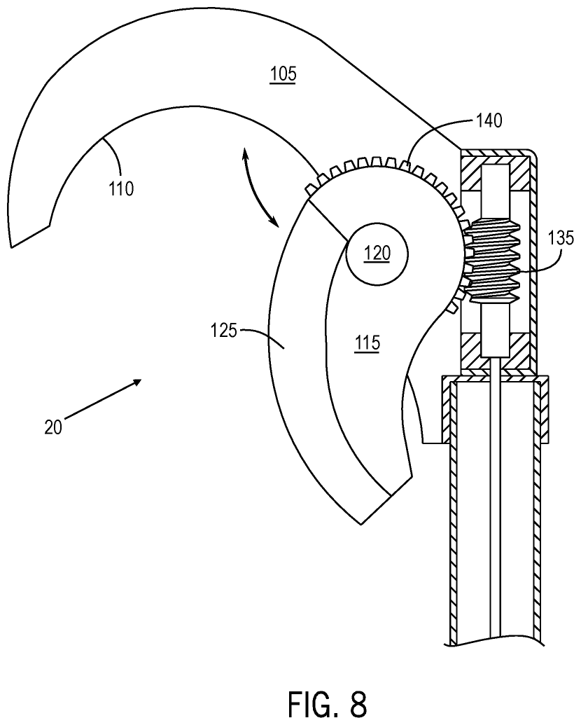

The interior 97 of extension pole 10 is hollow and may be used to house various components of the extension pole system 5. For example, as shown in FIGS. 2 and 8, in an embodiment, an internal drive system 100 extends through the hollow interior 97 of extension pole 10. Thus, the user is able to control, for example, the upward and downward movement of blade 55 (FIG. 2) or the rotational movement of snipping unit 105 (FIG. 8)—or any other action performed by any other attachment 20 that may require a drive system. Additionally, or alternatively, the hollow interior 97 of extension pole 10 may house electric wiring for providing electrical communication between various electrical components of extension pole system 5.

With reference to FIG. 8, the saw of FIGS. 1-4 and 7 may be removed and replaced with snipping unit 105 or other attachment (not shown). Snipping unit 105 may have first blade 110 and second blade 115 and may rotate at pivot pin 120. Second blade 115 may have cutting surface 125 that interacts with first blade 110 to cut, for example, a tree limb/branch 45 or portion of tree 130. Second cutting blade 115 may be controlled by screw mechanism 135 (e.g., a worm gear/drive) which interacts with teeth 140 of second blade 115. It should be understood that, while the drawings show cutting devices coupled to the upper end of extension pole 10, the drawings are provided for illustrative purposes only and are not meant to limit the scope of the present invention to any particular attachment 20. As such, any attachment that is suitable/desirable for attachment to an extension pole may be used with the present invention.

In order to aid in the understanding of the mechanics of the present invention, an example will now be given of how one embodiment of an extension pole system, in accordance with the present invention, is used. The following method of use is for illustrative purposes and should not be interpreted as being limiting. While in the collapsed orientation, an attachment 20 is coupled to extension pole 10. With attachment 20 coupled to extension pole 10, extension pole system is oriented vertically with foot brace 15 resting on the ground surface 34. Next, with the user's foot 145 disposed in/through foot brace 15, the user reaches up with both hands (see FIG. 10) to extend sections 25, one at a time, from the base section 25 to transition extension pole 10 from the collapsed orientation to the expanded orientation. This process begins with extending the uppermost section 25 and locking it into place using the locking mechanism at joints 30. Once locked, the next successive section 25 (from the uppermost section 25) is extended and locked into place. This process is repeated for all sections 25, one at a time, until a desired height is reached or all sections 25 are extended. When the user is done working, he/she reaches up with both hands, unlocks joint 30 to release section 25 adjacent to base section 25 so that it can be collapsed into base section 25. This process is repeated for all sections 25, one at a time, until all sections 25 are collapsed into base section 25.

The invention has been described herein using specific embodiments for the purposes of illustration only. It will be readily apparent to one of ordinary skill in the art, however, that the principles of the invention can be embodied in other ways to achieve the same purposes without departing from the scope of the invention. Likewise, it will be readily apparent that the features, functions, elements, and/or steps of the present invention disclosed herein can be used in any combination or order to produce various embodiments of the present invention. This application is intended to cover any adaptations or variations of the embodiments discussed herein. The invention should not be regarded as being limited in scope to the specific embodiments disclosed herein, but instead as being fully commensurate in scope with the following claims.

I claim:

1. An extension pole system comprising:
a. an extension pole configured to transition between a collapsed orientation and an extended orientation; and
b. a foot brace coupled to a lower end of the extension pole,
wherein the foot brace is configured to receive a foot of a user,
wherein an upper end of the extension pole is configured to releasably couple to an attachment.

2. The system of claim 1, wherein the extension pole comprises:
i. a plurality of extension sections; and
ii. locking means configured to releasably lock the extension sections in place.

3. The system of claim 1, wherein the foot brace comprises one or more spikes configured to secure the foot brace to a ground surface.

4. The system of claim 1, wherein the extension pole is permanently attached to the foot brace.

5. The system of claim 1, wherein the foot brace is integrally formed as part of extension pole.

6. The system of claim 1, wherein the foot brace is removably coupled to the extension pole.

7. The system of claim 1, wherein the attachment is selected from the group consisting of a manual tool, a power tool, a cleaning tool, a cleaning device, a cleaning apparatus, a painting tool, a painting device, a painting apparatus, and a camera.

8. The system of claim 1, wherein, when the system is upright and in the collapsed orientation, an upper end of the extension pole is disposed between 4 and 7 feet above a ground surface.

9. The system of claim 1, wherein the extension pole comprises a handle.

10. The system of claim 9, wherein the extension pole further comprises a strap configured to secure the extension pole to an object or the user.

11. The system of claim 10, wherein the handle and the strap are disposed on opposite sides of the extension pole.

12. The system of claim 1, wherein the extension pole comprises a strap configured to secure the extension pole to an object or the user.

13. A foot brace for an extension pole, the foot brace comprising:
a. an opening configured to receive a foot of a user; and
b. one or more spikes configured to secure the foot brace to a ground surface,
wherein an upper portion of the foot brace is configured to couple to the extension pole,
wherein the foot brace is configured to stabilize the extension pole when the extension pole is in an upright position.

14. The foot brace of claim 13, wherein the foot brace is configured to releasably couple to the extension pole.

15. A method of using an extension pole system, the system comprising:
a. an extension pole comprising a plurality of extension sections, wherein the extension pole is configured to transition between a collapsed orientation and an extended orientation;
b. a foot brace coupled to a lower end of the extension pole; and
c. an attachment releasably coupled to an upper end of the extension pole, the method comprising:
with the extension pole in the collapsed orientation:
coupling the attachment to the upper end of the extension pole;
orienting the extension pole in a vertical position with the foot brace resting on a ground surface;
positioning the user's foot within the foot brace and applying downward force on a base portion of the foot brace, the base portion being located underneath the user's foot;
extending the sections to transition the extension pole from the collapsed orientation to the expanded orientation; and
with the extension pole in the extended orientation:
collapsing the sections to transition the extension pole from the extended orientation to the collapsed orientation.

16. The method of claim 15, wherein the foot brace comprises one or more spikes configured to secure the foot brace to a ground surface.

17. The method of claim 15, wherein applying downward force on the base portion of the foot brace is configured to stabilize the extension pole in the vertical position, wherein the user is able to use both of his/her hands to transition the extension pole between the collapsed orientation and the extended orientation.
